(19) United States
(12) Patent Application Publication
(10) Pub. No.: US 2026/0167803 A1
(43) Pub. Date: Jun. 18, 2026

(54) METHOD OF MANUFACTURING AN AQUEOUS DISPERSION

(71) Applicant: Kemira Oyj, Helsinki (FI)

(72) Inventors: Riina TAKAMAA, Espoo (FI); Anneli Lepo, Espoo (FI)

(21) Appl. No.: 19/127,067

(22) PCT Filed: Oct. 16, 2023
(86) PCT No.: PCT/EP2023/078703

§ 371 Date: May 2, 2025

(30) Foreign Application Priority Data
Nov. 4, 2022 (GB) 2216450.3

(51) Int. Cl. C08L 1/12; C08K 5/10; C08L 1/14

(52) U.S. Cl. CPC C08L 1/12; C08K 5/10; C08L 1/14; C08L 2666/02

(57) ABSTRACT

A method of manufacturing an aqueous dispersion of a polymer comprises preparing an aqueous medium, the aqueous medium being an aqueous emulsion or suspension of a water-insoluble plasticiser, the aqueous medium including a dispersant; preparing a polymer melt; and combining the aqueous medium and the polymer melt to form the aqueous dispersion. By providing an aqueous medium comprising the combination of a water-insoluble plasticiser and a dispersant, it is made possible to prepare an aqueous dispersion of a polymer without the use of organic solvents and without pressurizing the aqueous medium or polymer melt. Also provided are a method of manufacturing a coated substrate using the aqueous dispersion; an aqueous dispersion of a polymer; and a use of an aqueous medium.

### BACKGROUND

Plastic packaging materials are commonly used to package foods and beverages. Plastics are inexpensive to manufacture and to transport, and are effective barriers against moisture and oil and grease. However, plastics have a significant environmental impact. For example, most plastics are produced from non-renewable resources, are not biodegradable, and are challenging to recycle. There is an increasing desire to reduce the amount of plastic waste.

Glass and metal packaging may be used as alternatives to plastics. These materials have good barrier properties, and can readily be recycled. However, glass and metal suffer from the drawbacks that they are expensive to manufacture and to transport.

Cellulosic materials such as paperboard are attractive materials from an environmental standpoint because they are manufactured from renewable materials and are biodegradable. However, cellulosic materials are often porous and absorbent, and usually do not have adequate moisture and oil and grease barrier properties.

The moisture and oil and grease barrier properties of a cellulosic material may be enhanced by coating the material with a polymer. The polymer may be applied in the form of a dispersion of polymer particles in a liquid phase. Existing techniques for preparing such dispersions involve the use of large quantities of organic solvents and/or energy-intensive processing conditions such as high pressures and temperatures. It would be desirable to provide a method of manufacturing a coating composition which has less environmental impact.

### SUMMARY

In one aspect, there is provided a method of manufacturing an aqueous dispersion of a polymer. The method comprises preparing an aqueous medium, the aqueous medium being an aqueous emulsion or suspension of a water-insoluble plasticiser, the aqueous medium including a dispersant; preparing a polymer melt; and combining the aqueous medium and the polymer melt to form the aqueous dispersion. It has surprisingly been found that, by providing an aqueous medium which is an aqueous emulsion or suspension comprising both a water-insoluble plasticiser and a dispersant, it is made possible to prepare an aqueous dispersion of a polymer without the use of organic solvents or processing pressures in excess of 1 atm.

The aqueous medium may be an aqueous emulsion of the water-insoluble plasticiser.

The dispersant may comprise a non-ionic surfactant. The dispersant may comprise a polymeric surfactant. The dispersant may comprise a polymeric non-ionic surfactant.

The polymeric non-ionic surfactant may comprise a polyvinyl alcohol or an analogue thereof. The polymeric non-ionic surfactant may comprise a partially-hydrolysed polyvinyl alcohol or an analogue thereof having a degree of hydrolysis of less than or equal to 98%, optionally less than or equal to 80%. The degree of hydrolysis of the partially-hydrolysed polyvinyl alcohol or analogue thereof may be in the range 50% to 98%, and optionally 75% to 85%. For example, the degree of hydrolysis of the partially-hydrolysed polyvinyl alcohol or analogue thereof may be about 80%. A general structural formula for partially-hydrolysed polyvinyl alcohols and their analogues is provided in the detailed description.

The water-insoluble plasticiser may comprise a fatty acid ester. For example, the water-insoluble plasticiser may comprise a compound of Formula 1:

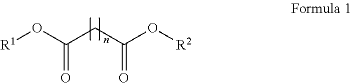

where:
n is in the range 2 to 26; and
R1 and R2 are each independently selected from C2 to C10 alkyl groups; C2 to C10 alkene groups; benzyl groups; and phenyl groups.

For example, the water-insoluble plasticiser may comprise dibutyl sebacate.

The aqueous medium may include less than 5% organic solvents by weight of the aqueous medium. It has been found that the use of organic solvents is not necessary for forming an aqueous dispersion of a polymer. Avoiding the use of organic solvents may reduce the environmental impact of the method.

The polymer melt may include a water-insoluble plasticiser. In such implementations, the water-insoluble plasticiser of the polymer melt may be the same as or different from the water-insoluble plasticiser of the aqueous medium.

The polymer may comprise a biobased polymer. For example, the polymer may comprise a cellulose ester, such as cellulose acetate butyrate. Alternatively or additionally, the polymer may comprise a polyhydroxyalkanoate.

Combining the aqueous medium and the polymer melt may comprise adding the polymer melt to the aqueous medium. The aqueous medium may be at a temperature of less than 100° C. and a pressure in the range 0.9 to 1.1 atm during the combining. Many polymers have melting points greater than 100° C. By adding the polymer melt to the aqueous medium, pressurising the aqueous medium may be avoided.

The aqueous dispersion may have a median particle size d(0.5) in the range 0.1 to 15 μm, optionally 0.3 to 10 μm, further optionally 0.5 to 3 μm as measured by laser diffraction.

The 90^{th} percentile particle size d(0.9) may be less than or equal to 30 μm, optionally less than or equal to 20 μm. For example, the 90^{th} percentile particle size d(0.9) may be in the range 15 to 30 μm.

In another aspect, there is provided a method of manufacturing a coated substrate. The method comprises manufacturing an aqueous dispersion of a polymer by the method described herein; applying the aqueous dispersion to a substrate; and drying the aqueous dispersion to form a coating on the substrate. The aqueous dispersions provided herein are useful for forming coatings. Such coatings may, for example, improve the barrier properties of a substrate.

The substrate may be in the form of a sheet. Alternatively, the substrates may be in the form of fibres. For example, the aqueous dispersion may be used for paper sizing.

The substrate may comprise a cellulosic material. By forming a coating on a cellulosic substrate, a renewable, recyclable and repulpable packaging material may be obtained. Such a packaging material may be useful for packaging foods, beverages, and the like.

Still another aspect provides an aqueous dispersion of a polymer suitable for forming a coating on a substrate. The dispersion comprises water; dispersed particles of the polymer; a water-insoluble plasticiser; and a dispersant. The dispersed particles of the polymer have a median particle size d(0.5) in the range 0.1 to 15 μm as measured by laser diffraction. The aqueous dispersion has a solids content of at least 20% by weight of the aqueous dispersion. The aqueous dispersion is obtainable by the method provided herein. The method may allow an aqueous dispersion having a high solids content and favourable particle size distribution to be obtained.

As will be appreciated, the discussion of the various materials provided herein with reference to the method aspects is equally applicable to the aqueous dispersion aspect. For example, the polymer may be a cellulose ester, optionally cellulose acetate butyrate; the water-insoluble plasticiser may be a fatty acid ester, optionally a fatty acid ester of Formula 1, further optionally dibutyl sebacate; and/or the dispersant may be a partially-hydrolysed polyvinyl alcohol having a degree of hydrolysis of less than or equal to 98%, and optionally a degree of hydrolysis in the range 50% to 90%, further optionally 75% to 85%.

In still another aspect, there is provided the use of an aqueous medium in the preparation of an aqueous dispersion of a polymer, the aqueous medium comprising: water; a water-insoluble plasticiser; and a dispersant; wherein the water-insoluble plasticiser is dispersed in the water; and wherein the use comprises combining the aqueous medium with a polymer melt to form the aqueous dispersion of the polymer. It has been found that, by providing an aqueous medium which is an emulsion or suspension including both a water-insoluble plasticiser and a dispersant, and then adding a polymer melt to the aqueous medium, a dispersion of the polymer may be obtained without heating the aqueous medium to above 100° C. and without the use of pressurization to prevent boiling of the aqueous medium.

The discussion the various components of the aqueous medium provided herein with reference to the method aspects is equally applicable to the use aspect.

For example, the water-insoluble plasticiser may be a fatty acid ester. The dispersant may be a partially-hydrolysed polyvinyl alcohol or an analogue thereof having a degree of hydrolysis, DH, of less than or equal to 98%. A general structural formula for partially-hydrolysed polyvinyl alcohols and their analogues is provided further below.

### BRIEF DESCRIPTION OF THE DRAWINGS

To assist understanding of embodiments of the present disclosure and to show how such embodiments may be put into effect, reference is made, by way of example only, to the accompanying drawings in which:

FIG. 1 is a flow diagram outlining an example method of manufacturing an aqueous dispersion of a polymer;

FIG. 2 is a flow diagram outlining an example method of manufacturing a coated substrate;

FIG. 3 is a schematic cross-section of a coated substrate obtainable by the method of FIG. 2; and

FIG. 4 is a plot showing a particle size distribution for an aqueous dispersion of a polymer obtained in accordance with Example 1.

### DETAILED DESCRIPTION

The verb ‘to comprise’ is used herein as shorthand for ‘to include or to consist of’. In other words, although the verb ‘to comprise’ is intended to be an open term, the replacement of this term with the closed term ‘to consist of’ is explicitly contemplated, particularly where used in connection with chemical compositions.

A “biobased” material contains carbon, with at least 30%, preferably at least 50%, and most preferably all of the carbon in the material being derived from a renewable source. Carbon from renewable sources may be distinguished from carbon from fossil fuel sources by isotope analysis. Fossil fuel sources will be substantially free of ¹⁴C. Renewable sources will include ¹⁴C in a proportion approximately equal to the proportion present in the atmosphere, i.e. 1 to 2 ¹⁴C atoms per 10¹² atoms of total carbon. Thus, a biobased material comprises at least 0.3 ¹⁴C atoms per 10¹² atoms of total carbon, and preferably 1 to 2 ¹⁴C atoms per 10¹² atoms of total carbon.

“Ambient pressure” is a pressure of about 1 atm (101 kPa).

All particle sizes reported herein are measured by laser diffraction, using the method described in Example 1.

The solids content of a composition is measured by determining the change in mass which occurs when the composition is dried. Solids content may be conveniently measured using a commercially-available moisture/solids analysis device, such as the “SMART 6” available from CEM Corporation.

As used herein, the term “water-insoluble” describes a compound which has an intrinsic solubility of less than or equal to 0.1 g/L in 0.15 M aqueous KCl at a temperature of 25° C. An “intrinsic solubility” is measured at equilibrium and at a pH selected such that the compound is not ionised. For compounds that do not include ionisable groups, solubility may be measured at any pH.

Unless otherwise specified, all particle sizes reported herein are measured by laser diffraction, and all melting points reported herein are measured at ambient pressure.

Viscosity is measured at 20° C., using a Brookfield LVDV viscometer, in a small sample adapter with spindle 18.

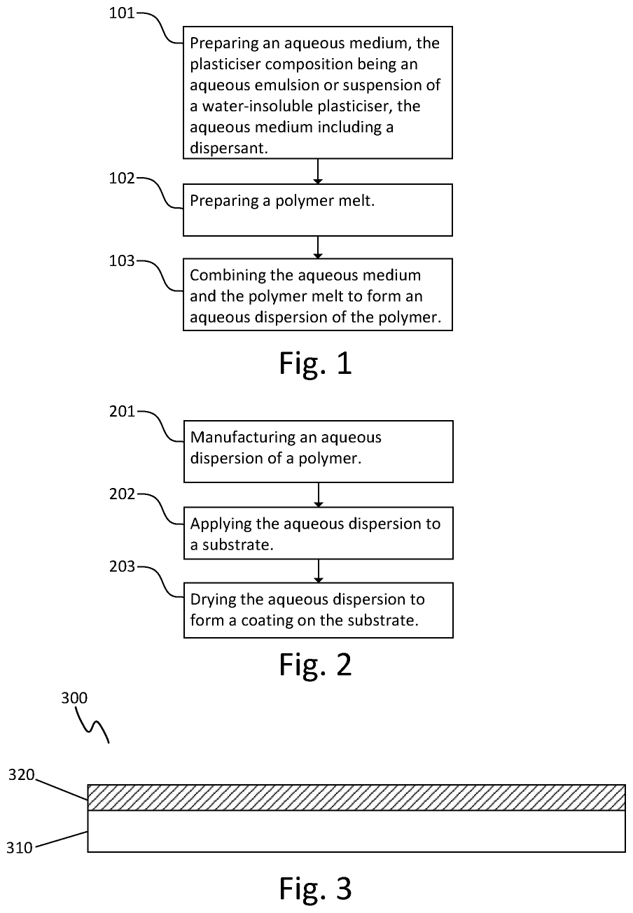

An example method of manufacturing an aqueous dispersion of a polymer will now be explained with reference to FIG. 1. FIG. 1 is a flow diagram outlining the method.

At block 101, an aqueous medium is prepared. The aqueous medium is an aqueous suspension or emulsion which includes a water-insoluble plasticiser and a dispersant. Preparing the aqueous medium may comprise dissolving the dispersant in water, and subsequently adding the water-insoluble plasticiser. Heat and/or stirring may be used to help to form the suspension or emulsion.

The aqueous medium may be a suspension or emulsion of the water-insoluble plasticiser, depending upon the melting point of the water-insoluble plasticiser. The aqueous medium is preferably an aqueous emulsion. The continuous phase comprises water, and the disperse phase comprises the water-insoluble plasticiser.

The nature of the water-insoluble plasticiser is not particularly limited provided that an aqueous emulsion or suspension of the plasticiser can be obtained. The water-insoluble plasticiser may be selected as appropriate based on the nature of the polymer to be included in the dispersion.

The water-insoluble plasticiser may be a fatty acid ester. Fatty acid esters may be prepared from biobased materials, and may have a smaller environmental impact than other water-insoluble plasticisers such as phthalate derivatives.

Examples of fatty acid esters include those of Formula 1:

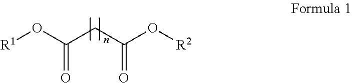

where:
n is in the range 2 to 26; and
R1 and R2 are each independently selected from C2 to C10 alkyl groups; C2 to C10 alkenyl groups; benzyl groups; and phenyl groups.

Optionally, n may be in the range 4 to 10, and further optionally 6 to 9. For example, the fatty acid ester may be an adipate ester (n=4) or a sebacate ester (n=8), preferably a sebacate ester (n=8).

R1 and R2 are optionally each selected from C2 to C10 alkyl groups. Further optionally, R1 and R2 are both butyl groups.

Particularly preferably, the water-insoluble plasticiser may be dibutyl sebacate (n=8, R1=C4 linear alkyl, R2=C4 linear alkyl).

Fatty acid esters of Formula 1 may be particularly suitable in implementations where the polymer to be dispersed is a cellulose ester, such as cellulose acetate butyrate.

Other examples of water-insoluble plasticisers include water-insoluble citrate esters. Examples of citrate esters useful as plasticisers include those of Formula 2:

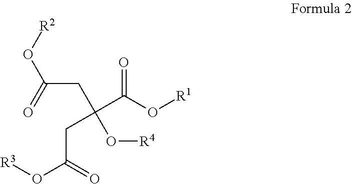

where:
R1, R2, and R3 are each independently selected from C2 to C6 alkyl groups, C3 to C6 alkenyl groups, benzyl groups; and phenyl groups; and
R4 is selected from H, C2 to C6 alkyl groups, C3 to C6 alkenyl groups, benzyl groups, phenyl groups, and C2 to C6 acyl groups.

Optionally, R1, R2, and R3 are each independently selected from C3 to C5 alkyl groups.

R4 is optionally an acetyl group (i.e., a C2 acyl group).

An example of a water-insoluble citrate ester of Formula 2 is acetyl tributyl citrate.

Water-insoluble triglycerides are still another class of useful plasticisers. For example, a triglyceride plasticiser of Formula 3 may be used:

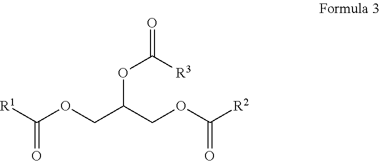

where:
R1, R2, and R3 are each independently selected from C1 to C14 alkyl groups, C3 to C14 alkenyl groups, benzyl groups; and phenyl groups.

Example compounds of Formula 3 include triacetin (R1=C1 alkyl, R2=C1 alkyl, R3=C1 alkyl); tributyrin (R1=C3 alkyl, R2=C3 alkyl, R3=C3 alkyl), and trilaurin (R1=C11 alkyl, R2=C11 alkyl, and R3=C11 alkyl).

Still further examples of water-insoluble plasticisers include glycerol esters of fatty acids, e.g. glycerol monostearate; and alkyl esters of fatty acids, e.g. methyl oleate.

The aqueous medium includes the water-insoluble plasticiser in an amount which is effective to allow an aqueous dispersion of the polymer to be obtained when the aqueous medium is combined with a polymer melt as described later with reference to block 103.

The aqueous medium further comprises a dispersant. The dispersant allows a dispersion, i.e. an emulsion or suspension, of the water-insoluble plasticiser to be formed. The dispersant may be referred to as a surfactant or emulsifying agent.

The dispersant may comprise a non-ionic surfactant. The dispersant may comprise a polymeric surfactant. The dispersant may comprise a polymeric non-ionic surfactant.

Examples of polymeric non-ionic surfactants include polyvinyl alcohols; polyvinyl alcohol copolymers, for example polyacrylic acid-polyvinyl alcohol block copolymers and ethylene vinyl alcohol co-polymers; polysorbates; poloxamers; and alkyl polyglycosides.

Water-soluble, non-ionic polysaccharides such as hydroxyalkyl celluloses, and gums such as xanthan gum are also useful as polymeric non-ionic surfactants. In particular, the water-soluble non-ionic polysaccharide may be a hydroxyalkyl cellulose. For example, the water-soluble polysaccharide may comprise a hydroxyalkyl cellulose ether bearing hydroxyalkyl groups selected from hydroxymethyl, hydroxyethyl, hydroxypropyl, hydroxybutyl, and combinations thereof.

Some methods of manufacturing water-soluble polysaccharides result in a product with a small negative charge, due to the presence of a small number of carboxylic acid groups. These water-soluble polysaccharides are considered to be non-ionic surfactants provided that the negative charge does not substantially modify the surfactant properties of the water-soluble polysaccharide. For example, a hydroxyalkyl cellulose ether which a degree of substitution for anionic groups of less than 0.03 may be considered non-ionic.

Additional examples of non-ionic surfactants include lignins and polyol fatty acid esters.

The non-ionic surfactant may be a partially-hydrolysed polyvinyl alcohol, a partially-hydrolysed polyvinyl alcohol copolymer, or an analogue thereof. Such non-ionic surfactants comprise:
hydrophobic units of Formula 4A:

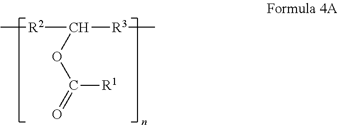

where:
   R1 is a methyl, ethyl, or propyl group;
   R2 is absent, a methylene group, or an ethylene group;
   R3 is absent, a methylene group, or an ethylene group; hydrophilic units of Formula 4B:

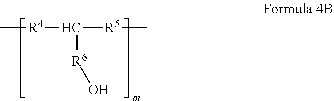

where:
   R4 is absent, a methylene group, or an ethylene group;
   R5 is absent, a methylene group, or an ethylene group;
   R6 is absent or a methylene group;
and optionally hydrophobic linkers of Formula 4C:

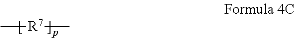

where:
   R7 is a C1 to C4 alkyl group.

The proportion of hydrophilic units present in the polymer of the above structural formula may be expressed in terms of a degree of hydrolysis, DH. The degree of hydrolysis has units of mol %, and is defined by Equation 1:

$$DH ( mol \% ) = \frac{m}{n + m + p} * 100 \qquad Equation 1$$

where n is the number of hydrophobic units of Formula 4A, m is the number of hydrophilic units of Formula 4B, and p is the number of hydrophobic linkers of Formula 4C.

The degree of hydrolysis is typically less than or equal to 98%, and is preferably less than or equal to 80%. The degree of hydrolysis may be in the range 50 to 98%, 50 to 80%, 75 to 98%, or 75 to 85%.

The term “degree of hydrolysis” has been adopted to refer to the parameter defined by Equation 1 because commercially-available polyvinyl alcohols are usually manufactured by hydrolysis of polyvinyl acetate. The use of this term does not place any limitation on how the non-ionic surfactant is synthesized.

The copolymer of the above general formula may be a random co-polymer or a block copolymer, and is most typically a random co-polymer.

The molecular weight of the copolymer of the above general formula is not particularly limited provided that the co-polymer is water-soluble and a dispersion of the water-insoluble plasticiser can be obtained. The molecular weight of the co-polymer may be selected such that a 4 wt % solution of the co-polymer has a viscosity of less than or equal to 150 mPa·s at 20° C.

Preferably, exactly one of R2 and R3 is absent; exactly one of R4 and R5 is absent; and R6 is absent.

The hydrophobic linker of Formula 4C may be absent, i.e. p may be 0. When the hydrophobic linker of Formula 4C is present, R7 is preferably an ethylene group.

Most preferably, the dispersant comprises a polyvinyl alcohol having a degree of hydrolysis of less than or equal to 98%, optionally less than or equal to 80%. The degree of hydrolysis may be in the range 50% to 98%, optionally 75% to 98%, and is further optionally in the range 75 to 85%. Polyvinyl alcohols are biodegradable.

The dispersant may comprise a small molecule non-ionic surfactant, in other words a non-ionic surfactant which is not a polymer. Examples of small-molecule non-ionic surfactants include fatty alcohols and mixtures thereof, such as oleyl alcohol, cetyl alcohol and cetostearyl alcohol; ethanolamines such as cocamide monoethanolamine and cocamide diethanolamine; glucosides such as octyl glucoside, lauryl glucoside, and decyl glucoside; and sorbitan esters.

Combinations of two or more surfactants may be used. For example, the dispersant may comprise a non-ionic polymeric surfactant and a small molecule non-ionic surfactant. In such implementations, the small molecule non-ionic surfactant may be referred to as a co-surfactant.

The dispersant is present in the aqueous medium in an amount which is effective to allow a dispersion of the water-insoluble plasticiser to be obtained. The amount of dispersant may be selected as appropriate based on the nature and quantity of water-insoluble plasticiser to be included in the aqueous medium.

On a dry basis, the weight ratio of water-insoluble plasticizer to dispersant may be in the range 1:99 to 50:50, and optionally in the range 5:95 to 50:50.

The solids content of the aqueous medium is typically at least 1% by weight based on the total weight of the aqueous medium, and may for example be in the range 5 to 50% or 20 to 50%. Higher solids contents may be used.

The aqueous medium may further comprise one or more additional components, for example an acid, base, or buffer system for controlling the pH of the aqueous phase of the aqueous medium. An example of a useful acid is acetic acid.

The methods described herein do not require the use of organic solvents. The aqueous medium is preferably substantially free of organic solvents. For example, the aqueous medium may comprise no more than 5%, optionally no more than 0.5%, further optionally 0.05% organic solvents by weight of the aqueous medium.

The aqueous medium is typically prepared at ambient pressures (i.e. pressures of about 1 atm), with the temperature of the aqueous medium being below the boiling point of water. The aqueous medium may for example be prepared at a temperature in the range 15 to 95° C. By avoiding the use of high pressures and temperatures, energy consumption may be reduced.

At block 102, a polymer melt is prepared. The operations of this block comprise heating a polymer to a temperature above its melting point using a suitable device, such as an extruder or melt-kneading apparatus.

The nature of the polymer may be selected as appropriate depending upon the intended use of the polymer dispersion. The polymer is typically a water-insoluble polymer. In implementations where the polymer dispersion is to be used to form a coating on a substrate, the polymer is preferably a film-forming polymer. The polymer is preferably biobased.

The biobased film-forming polymer may be selected from carbohydrates, and derivatives thereof. A “derivative” is a polymer which has been chemically modified to include additional substituents.

Examples of film-forming polymers include polyacrylates; polyphenols; polyureas; polyisocyanates; polyolefins, such as polyethylene or polypropylene; polyesters, in particular biobased polyesters such as poly(lactic acid); polyamides; epoxy polymers; and polyvinyl acetate. Biobased polyesters may be referred to as polyhydroxyalkanoates.

The polymer may comprise a water-insoluble α-glucan or β-glucan.

Examples of water-insoluble α-glucans include glycogen; amylose; amylopectin; starch; and cyclodextrin.

Examples of β-glucans include cellulose and cellulose derivatives. The term “cellulose derivative” refers in particular to cellulose esters.

Preferably, the polymer comprises a cellulose ester, in particular a cellulose ester in which the ester groups are each individually selected from C1 to C18 alkyl ester groups, optionally C1 to C6 alkyl ester groups. The cellulose ester may include free hydroxyl groups and ester substituents.

The C1 to C6 alkyl ester groups are preferably each individually selected from acetate ester groups, propionate ester groups, and butyrate ester groups.

The cellulose ester may comprise one type of alkyl ester group, i.e. each of the alkyl ester groups may comprise the same group. For example, the cellulose ester may be cellulose acetate. Alternatively, the cellulose ester may comprise two or more different types of alkyl ester group. Examples of such cellulose esters include cellulose acetate propionate and cellulose acetate butyrate.

Particularly preferably, the polymer may comprise a cellulose acetate butyrate.

The polymer melt may comprise a single polymer, or a mixture of two or more different polymers.

In particular, mixtures comprising a cellulose ester and one or more compatible polymers are contemplated. Most cellulose esters are compatible with most polyacrylates; polyesters such as polyhydroxyalkanoates; polyphenols; polyureas; and polyisocyanates. Other examples of compatible polymers include polyolefins such as polyethylene or polypropylene; poly(lactic acid); cellulose esters such as cellulose acetate; regenerated cellulose (“Cellophane”); polyamides such as polyamide 11; epoxies; polyvinyl acetates; and lignin.

A water-insoluble plasticiser may optionally be included in the polymer melt. The water-insoluble plasticiser may be the same as or different from the water-insoluble plasticiser included in the aqueous medium described with reference to block 101. Any of the water-insoluble plasticisers described above may be used, for example dibutyl sebacate.

In implementations where the polymer melt includes a water-insoluble plasticizer, the water-insoluble plasticizer may be present in an amount of up to 50% by weight of the polymer melt.

After preparing the aqueous medium and polymer melt, the method proceeds to block 103, in which the aqueous medium and polymer melt are combined to form an aqueous dispersion of the polymer.

The polymer melt may be added to the aqueous medium. For example, the polymer melt may be formed in the barrel of an extrusion apparatus and then extruded from the barrel into a vessel containing the aqueous medium.

Adding the polymer melt to the aqueous medium may allow the polymer melt to be combined with the aqueous medium at ambient pressure, even if the melting point of the polymer exceeds 100° C. Combining the aqueous medium and polymer melt at ambient pressure may allow a less complex apparatus to be used and/or may reduce energy consumption.

The temperature of the aqueous medium is maintained below the boiling point of water, and optionally does not exceed 95° C. For example, the weight ratio of polymer melt to aqueous medium and/or the rate of addition of the polymer melt to the aqueous medium may be adjusted such that the temperature of the aqueous medium does not exceed the boiling point of water.

The aqueous medium may optionally be heated before adding the polymer melt. For example, the aqueous medium may be heated to a temperature of less than or equal to 85° C., and optionally to a temperature in the range 70 to 85° C. Varying the temperature of the aqueous medium may modify the particle size distribution of the dispersion obtained by the method. Minimizing the amount of heating may be desirable to reduce energy consumption.

Generally, the aqueous medium is agitated, for example stirred, as the polymer melt is added. The rate of addition of the polymer melt and the amount of agitation are selected such that an aqueous dispersion of the polymer is obtained. As the rate of addition increases, the level of agitation also increases.

The weight ratio of polymer melt to aqueous medium may be selected as appropriate. The polymer dispersion may, for example, have a solids content of at least 20% by weight, optionally in the range 20 to 70% by weight, based on the total weight of the polymer dispersion. A high solids content may allow a continuous film or coating to be formed in a single coating operation.

The polymer melt may provide 10 to 80 wt %, optionally 20 to 75 wt %, and further optionally 30 to 75 wt % of the solids content.

It has been found that when a polymer melt is combined with an aqueous medium which includes both a water-insoluble plasticiser and a dispersant, a dispersion of the polymer is obtained. The dispersion of the polymer may be obtained without pressurizing the aqueous medium and without heating the aqueous medium to a temperature greater than 100° C.

The aqueous dispersion of the polymer may have a viscosity of less than or equal to 4,000 mPa·s, and optionally less than or equal to 2,500 mPa·s. For example, the viscosity of the aqueous dispersion of the polymer may be in the range 5 to 2,000 mPa·s or 1,000 to 2,000 mPa·s.

Various modifications may be made to the example method.

FIG. 1 illustrates a method in which the aqueous medium is prepared before the polymer melt. These two operations may be performed in any order, or simultaneously.

The method may be implemented as a batch process or as a continuous process.

In the example, the polymer melt is added to the aqueous medium. Adding the polymer melt to the aqueous medium may be preferable when the melting point of the polymer is greater than or equal to 100° C. In alternative implementations, the aqueous medium may be added to the polymer melt, particularly if the melting point of the polymer is less than 100° C.

The aqueous dispersions obtainable by the methods provided herein may be used to form barrier layers or coatings on substrates. An example method of manufacturing a coated substrate will now be described with reference to FIG. 2. An example product 300 obtainable by the method is shown in FIG. 3.

First, at block 201, an aqueous dispersion of a polymer is manufactured in accordance with the method of FIG. 1.

Optionally, one or more further components may be mixed with the aqueous dispersion. Examples of further components include pigments, cobinders, and rheology modifiers.

Subsequently, at block 202, the dispersion is applied to the surface of the substrate 310. Any appropriate coating technique may be used to apply the dispersion to the surface. Examples of coating techniques include casting, rod coating, curtain coating, and spraying.

Finally, at block 203, the dispersion is dried to form a coating 320 on the substrate 310. The thickness of coating 320 is determined by the amount of dispersion applied to the substrate, and the solids content of the dispersion. The amount of dispersion applied to the substrate is typically selected such that a continuous film forms on the surface of the substrate 310.

The nature of the substrate 310 is not particularly limited. The substrate may be a cellulosic substrate, in particular a biobased cellulosic substrate. The cellulosic substrate may, for example, comprise paper, paperboard, fibreboard, or a textile such as cotton fabric. In implementations where the cellulosic substrate comprises paper or paperboard, the material may be used as packaging for food or beverages.

The coating 320 may improve the barrier properties of the substrate, and in other words may increase the resistance of the substrate 310 to one or more of water vapor, liquid water, oil, and grease.

In the illustrated example, the coating 320 is applied on only one surface of the substrate 310. In other implementations, both surfaces of the substrate 310 may be coated.

The example includes one layer of coating 320. In variants, two or more layers may be applied.

The illustrated substrate 310 is in the form of a single sheet of material. The substrate may alternatively be a multi-layer sheet.

The substrate is not necessarily in the form of a sheet. In variants, the substrate is in the form of fibres. The fibres may be biobased fibres, e.g. cellulosic fibres. Coated fibres may be useful in the manufacture of sheets.

### EXAMPLES

### Example 1

An aqueous medium was prepared by adding 1 mL of dibutyl sebacate to 20 mL of a 10 wt % aqueous solution of partially-hydrolysed polyvinyl alcohol. The mixture was stirred at room temperature until a white emulsion formed.

The emulsion was placed under a melt flow index apparatus, and heated to 80° C. while stirring.

A polymer blend was prepared by mixing 4 g of cellulose acetate butyrate and 3 ml of dibutyl sebacate. The polymer blend was loaded into the melt flow index apparatus, and melted by heating the blend to a temperature of 220° C. The resulting polymer melt was added to the emulsion dropwise, while stirring the emulsion and maintaining the emulsion at a temperature of 80° C.

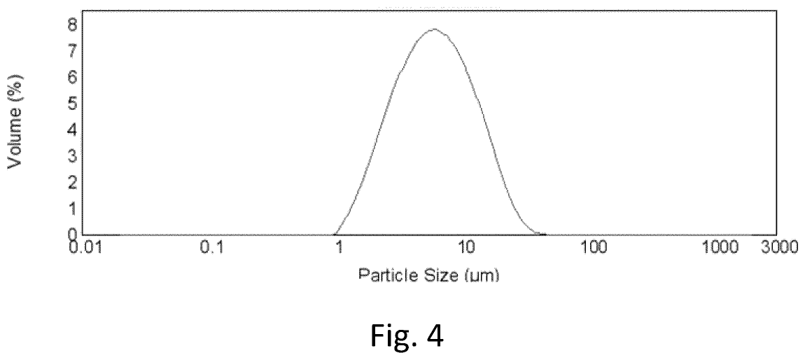

An aqueous dispersion of the polymer was obtained. Stirring was stopped, and the dispersion was allowed to cool to room temperature. The emulsion was observed to be stable. The particle size distribution of the emulsion was determined by laser diffraction, using a Malvern Mastersizer 2000. The results of the measurement are shown in FIG. 4 and the table below.

| Volume-based percentile | Size/μm |
|---|---|
| d(0.05) | 1.888 |
| d(0.1) | 2.35 |
| d(0.5) | 6.033 |
| d(0.9) | 15.301 |

d(0.1), d(0.5) and d (0.9) are the respective 10%, 50% and 90% volume-based percentiles. That is e.g. 10% of the particles by volume are smaller than the given value d(0.1) in μm. d(0.5) is the median particle size.

### Comparative Example

The steps described in Example 1 were repeated, omitting the dibutyl sebacate from the aqueous medium.

No dispersion was formed. The polymer separated from the aqueous phase.

1. A method of manufacturing an aqueous dispersion of a polymer, which method comprises:
preparing an aqueous medium, the aqueous medium being an aqueous emulsion or suspension of a water-insoluble plasticiser, the aqueous medium including a dispersant;
preparing a polymer melt; and
combining the aqueous medium and the polymer melt to form the aqueous dispersion.

2. The method according to claim 1, wherein the aqueous medium is an aqueous emulsion of the water-insoluble plasticiser.

3. The method according to claim 1, wherein the dispersant comprises a non-ionic polymeric surfactant.

4. The method according to claim 3, wherein the non-ionic polymeric surfactant comprises a polyvinyl alcohol.

5. The method according to claim 4, wherein the polyvinyl alcohol is a partially-hydrolysed polyvinyl alcohol having a degree of hydrolysis of less than or equal to 98%.

6. The method according to claim 1, wherein the water-insoluble plasticiser comprises a fatty acid ester.

7. The method according to claim 6, wherein the fatty acid ester comprises a compound of Formula 1: 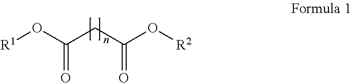
where:
n is in the range 2 to 26; and
R1 and R2 are each independently selected from C2 to C10 alkyl groups; C2 to C10 alkene groups; benzyl groups; and phenyl groups.

8. The method according to claim 7, wherein the water-insoluble plasticiser comprises dibutyl sebacate.

9. The method according to claim 1, wherein the aqueous medium includes less than 5% organic solvents by weight of the aqueous medium.

10. The method according to claim 1, wherein the polymer melt includes a water-insoluble plasticiser.

11. The method according to claim 1, wherein the polymer comprises a bio-based polymer.

12. The method according to claim 11, wherein the polymer comprises a cellulose ester.

13. The method according to claim 12, wherein the cellulose ester comprises a cellulose acetate butyrate.

14. The method according to claim 1, wherein combining the aqueous medium and the polymer melt comprises adding the polymer melt to the aqueous medium.

15. The method according to claim 14, wherein the aqueous medium is at a temperature of less than 100° C. and a pressure in the range 0.9 to 1.1 atm during the combining.

16. The method according to claim 1, wherein the aqueous dispersion has a median particle size d(0.5) in the range 0.1 to 15 μm as measured by laser diffraction.

17. A method of manufacturing a coated substrate, which method comprises:
manufacturing an aqueous dispersion of a polymer by the method according to any preceding claim;
applying the aqueous dispersion to a substrate; and
drying the aqueous dispersion to form a coating on the substrate.

18. The method according to claim 17, wherein the substrate comprises a cellulosic material.

19. An aqueous dispersion of a polymer suitable for forming a coating on a substrate, the aqueous dispersion comprising:
a continuous phase comprising water;
dispersed particles of the polymer;
a water-insoluble plasticiser; and
a dispersant;
wherein the dispersed particles of the polymer have a median particle size d(0.5) in the range 0.1 to 15 μm as measured by laser diffraction; and
wherein the aqueous dispersion has a solids content of at least 20% by weight of the aqueous dispersion.

20. The aqueous dispersion according to claim 19, wherein:
the polymer is a cellulose acetate butyrate;
the water-insoluble plasticiser is a fatty acid ester; and
the dispersant is a partially-hydrolysed polyvinyl alcohol having a degree of hydrolysis of less than or equal to 80%.

21. (canceled)
